(19) United States
(12) Patent Application Publication
(10) Pub. No.: US 2008/0139267 A1
(43) Pub. Date: Jun. 12, 2008

(54) Multi-hand blackjack video game

(76) Inventor: Kathleen Nylund Jackson, Scituate, MA (US)

Correspondence Address: MARK A. LITTMAN & ASSOCIATES, PA, YORK BUSINESS CENTER, SUITE 205, 3209 WEST 76th ST, EDINA, MN, 55435, US

(21) Appl. No.: 10/335,554

(22) Filed: Dec. 31, 2002

(51) Int. Cl. G06F 17/00

(52) U.S. Cl. 463/12; 273/292

(57) ABSTRACT

A method of playing multiple card games on video gaming apparatus is based on the conventional manner of play of Twenty-One. The game comprises at least one player making at least a first wager and at least a second wager, the first wager and the second wager defining a total initial wager, the total initial wager being equal to or exceeding at least four minimum wagers allowed for play of one of said multiple card games. The players are then dealt an initial first hand of two equivalent cards to the at least one each player in a first hand, second hand, third hand and fourth hand positions controlled by the at least one player to form a total of at least four player hands, the at least four player hands forming multiple player hands. The total initial wager is distributed among the multiple player hands so that at least four hands have wagers equal to or exceeding the minimum wagers allowed for play of one of said multiple card games. The dealing at least one face up card to the dealer comprises the dealer's hand, the at least one face up card being provided relative to each of the four player hands in the multiple player hands. The player's first hand is associated in play with at least one other of the second player's hand, the third player's hand, or the fourth player's hand to form a first group of player's hands for play against dealer's hands;

### BACKGROUND OF THE INVENTION

1. Field of the Invention

The present invention relates to video gaming, particularly blackjack or 21 games played on video gaming equipment, and most particularly to variations of blackjack on video gaming equipment where multiple games may be played at about the same time.

As played in most gaming casinos presently, conventional Twenty-One involves a game of chance between a dealer and one or more players. The object is for the player to achieve a final numerical count of his hand closer to 21 than the final numerical count of the hand of the dealer. This final count of the player must be equal to or lower than 21, for if the numerical count of the player's hand goes over 21, he busts or breaks and then the player loses the initial wager regardless of the final numerical count of the dealer's hand. The conventional manner of play of Twenty-One or Blackjack is as follows: Each player places an initial wager on the play of a hand of Twenty-One. One or more standard decks of playing cards are used and each card counts its face value (with Jacks, Queens and Kings counting 10). Aces have a value of one or eleven at the option of the player or dealer, based upon which valuation is most beneficial to the count of the hand. Each player initially receives two cards, usually face up. The dealer also receives two cards. One of the dealer's cards is dealt face down and the other of the dealer's cards is dealt face-up. In some gaming establishments, the dealer receives his two cards at the same time that each player is dealt his two cards. In other gaming establishments, the dealer initially only receives one card which becomes the dealer's “up” card. After each player has had the opportunity to take additional cards (“hits”), the dealer then receives his second card.

A player may draw additional cards to try and beat the anticipated count of the dealer's hand or at least to establish an improved count in the player s hand. If the player takes additional cards so that the player's numerical count exceeds 21, the player “busts”. The player may stand on any numerical count of 21 or less. When a player busts, the player loses the initial wager regardless of whether or not the dealer busts when the dealer draws additional cards to his hand.

After all of the players have taken hits or have stood on their hand, the dealer exposes the dealer s cards and then “stands” or “hits” based on pre-established rules for the game. Typically, if the dealer has less than 17, the dealer must take a hit. If the dealer has 17 or more, the dealer stands. As the game of Twenty-One is played in most legalized gaming establishments, the conventional manner of play requires the dealer to take a hit whenever the dealer's hand is a “soft 17” numerical count. However in other gaming establishments, the dealer stands on a “soft 17” numerical count. The term “soft” means that the Ace is valued as a count of 11, instead of as a count of 1. A soft 17 occurs when the dealer has an Ace and a Six (or multiple cards that add up to 6). The dealer will always stand on soft 18's, soft 19's soft 20's and soft 21's.

After the dealer's final hand count has been established, the numerical count of the dealer's hand is compared to the numerical count of player's hands that are still in the game (i.e., they have not busted or surrendered). If the dealer busts, the player wins regardless of the numerical count of his hand. If neither the player nor the dealer has busted, the closest hand to a numerical count of 21, without going over, wins; tie hands are a “push”.

There are other procedures that are included in the conventional manner of play of Twenty-One. One well-known procedure is “Doubling Down”. If the player believes that the comparative state of the player s hand versus the partially disclosed state of the dealer s hand (as represented by a single disclosed card) offers the player a desirable opportunity to increase the initial wager while receiving a single card from the dealer, the player may elect to double-down. Normally, doubling down is done when the player's first two cards have a combined value of 10 or 11. It is more preferred for the dealer s exposed card to be between 2 and 6. The player may “double down” on his hand, anticipating that the dealer may bust, irrespective of the final count of the player s hand. The player turns both of his cards face-up in front of him and makes a second wager less than or equal to, but not more than, the amount of the player's initial wager. The dealer deals to the player one additional card and the resulting three card hand establishes the final numerical count for the player's hand. Some “Doubling Down” rules permit the player to “double down” only on 10 or 11 counts. Other variations allow players to “double down” on 9, 10 or 11; only on 11; or on any two cards. Another well-known strategy is “Splitting Pairs”. If the player's first two cards are a pair, the player may “split” those cards into two separate hands. The initial wager is applied to one of the hands and the player makes an additional wager in the same amount on the other hand. The player receives a new second card for each of the split hands. Each of the split hands is then played separately and the player proceeds on each separate hand by standing or taking hits until he has achieved a hand count upon which he wishes to stand or until he busts. However, if the player splits Aces, then under the most common rule the player may receive only one extra card on each Ace, unless the extra card is an Ace in which the case the player may again split the pair of Aces.

The player may “double down” on either or both of his split hands if he is eligible to do so under the “Doubling Down” rules. The player may split again if he pairs up on either or both of his split hands. In most gaming establishments, a player may also split his hand if both of his initial cards are ten count cards (Tens, Jacks, Queens or Kings). For example, a player can split if he receives a Ten and a Queen, or a Jack and a King, or any combination of ten count cards. Because a hand count of 20 is a good hand to have, most experienced Twenty-One players are reluctant to risk such a hand by “splitting”.

Another well-known procedure is an Insurance wager. If the dealer's up card is an Ace, the player may make an additional Insurance bet. The insurance bets are made after each player receives his first two cards and the dealer reveals the dealer s face-up card as an Ace. The dealer s exposed card must be an Ace for insurance to be available. The insurance wager is made before any additional cards are dealt. When the dealer's up card is an Ace, each player can wager one-half of the amount of his original ante as insurance against the dealer having a Blackjack, i.e. a two-card 21 count (an Ace and a 10 count card such as a King, Queen, Jack or Ten). If the dealer has a Blackjack, the player loses on his original ante but wins two-to-one odds on his insurance bet. If the dealer has a Blackjack, that round of the game is over and all players lose except those who also have Blackjacks, who then tie or “push” with the dealer. If the dealer does not have a Blackjack, the player loses on his insurance bet and the round of the game continues.

Another conventional feature that is often offered in Twenty-One games is the Surrender option. If the player chooses to Surrender, the player receives back half of his initial wager and folds his hand. This option is usually only available after the player has received his first two cards and before the player has taken any hits on his hand. This action is taken when the player believes that it is likely the player will lose the entire wager if the hand is played out.

As used in this disclosure and the accompanying claims, the terns “conventional Twenty-One” and “the conventional manner of play of Twenty-One” mean the game of Twenty-One as previously described and also including any of the known variations of the game of Twenty-One.

U.S. Pat. No. 5,154,429 (LeVasseur) discloses a Twenty-One game in which the player receives a single hand to play against multiple dealer's hands. The player makes one, two or three wagers depending upon how many dealer's hands the player wishes to play against. The player is dealt two cards and the dealer receives an original face up card. The player plays out his hand only once taking hits or standing as in conventional Twenty-One. Once the player has completed the play of his hand, the dealer then plays his hand out relative to the first wager made by the player. The outcome of this first play of the dealer's hand is determined relative to the player's hand. The dealer then discards all of his cards except the original face up card received by the dealer. The dealer then plays his hand out relative to the second wager made by the player. The player still uses his same first hand, but all the dealer's cards for his second hand are different except for the original face up card. Again the outcome of this second play of the dealer's hand is determined relative to the player's hand. Finally, a third dealer's hand is played in the same manner.

The method of play described in LaVasseur has been commercially successful in gaming casinos and played under the mark MULTIPLE ACTION“ Blackjack. But this method has the drawback that the player would have made three separate wagers and may receive a poor hand. The player must play a single hand with regard to all of his wagers. If the player during the play of this single hand exceeds a numerical hand count of 21 (the player busts), the player will have lost all three wagers regardless of the outcome of the play of the dealer's hand.

A disadvantage of conventional Twenty-One is that each round of the game consists of one player's hand against one dealer's hand. Once the player draws his cards and achieves a hand count total on which he wishes to “stand,” the player has only a single opportunity to win or lose because the dealer is likewise playing only a single hand.

U.S. Pat. No. 5,954,335 describes a video blackjack game where the player makes two or more wagers at the beginning of the hand. The player is dealt two cards and the dealer receives his two cards. The player uses the first two cards as his first hand with his first wager and plays these two cards as he would in the conventional manner of play of Twenty-One. The player may Double Down, split pairs and take Insurance if those options are available under the house rules of play. After the player has completed the play of his first hand, he uses his original two cards again as the first two cards of his second hand with his second wager. Again, the player plays his second hand as he would in the conventional manner of play of Twenty-One. If the player has made three or more wagers, the player repeats the play of each hand again using his first two cards with each additional wager. Once the player has completed the play of his hands, the dealer plays out his hand as he would in the conventional manner of play of Twenty-One. Each of the player's hands is compared to the dealer's hand and winning wagers are paid and losing wagers are collected.

U.S. Pat. No. 6,311,978 describes a game of Twenty-One in which the player has the opportunity to play his first two cards multiple times. The player makes two or more wagers at the beginning of the hand. The player is dealt two cards and the dealer receives his two cards. The player's first two cards may be dealt two cards to each player, or may be dealt one card to each player and one community card common to all players or may be dealt as two community cards common to each player. The player uses the first two cards as his first hand with his first wager and plays these two cards as he would in the conventional manner of play of Twenty-One. The player may Double Down, split pairs, take Insurance and/or Surrender if those options are available under the house rules of play. After the player has completed the play of his first hand, he uses his original two cards again as the first two cards of his second hand with his second wager. Again, the player plays his second hand as he would in the conventional manner of play of Twenty-One. As with the first hand, with the second hand the player may Double Down, split pairs, take Insurance and/or Surrender if those options are available under the house rules of play. If the player has made three or more wagers, the player repeats the play of each hand again using his first two cards with each additional wager.

There is a need in Twenty-One for a modification in which the player has the opportunity to win more than once during each round of play and to take advantage when the player receives a good hand using methods that are different from the play of previous games.

There is also a desire in the industry for the gaming establishments to increase the amount of revenue generated by the game of Twenty-One in video formats. Although the game of Twenty-One is quite popular, the use of video gaming equipment where blackjack is played is quite limited. Increasing both the rate of play and the size of the average wager are desirable enhancements. This can most easily be accomplished by increasing the number of hands that can be dealt and played in any given time period.

### SUMMARY OF THE INVENTION

A video gaming system of play for potentially multiple hands of blackjack are provided. A player places a wager to engage in at least one blackjack game on the video gaming system. The dealer is dealt a single virtual hand (with one card displayed to the player) and the number of different dealer hands that may be played by a player against a single player s hand may be increased a) automatically by providing wagers in excess of the minimum wager or b) by election of the player with wagers in excess of the minimum wager. A maximum number of individual dealer hands may be provided both in play format a) and play format b). In the automatic format, as the amount of the wager exceeds a value equal to the maximum number of player hands allowed times the minimum wager, the wagers over this value are automatically distributed among the individual dealer hands in wagering unit increments. Similarly, if the player selects a specific number of hands, and the amount of the initial wager placed by the player exceeds the value of the number of games selected times the minimum wager per hand, the additional amount of the initial wager is automatically distributed among the individual dealer hands in wagering unit amounts.

### BRIEF DESCRIPTION OF THE FIGURES

FIG. 1 shows a blank touch-screen screen set-up for play of Triple Play“ blackjack.

FIG. 2 shows the beginning of a game of Triple Play“ blackjack with a $15.00 initial wager.

FIG. 3 shows a screen of FIG. 2 at a further stage of play of the game.

FIG. 4 shows a screen of FIGS. 2 and 3 at a further stage of play of the game.

FIG. 5 shows a screen of FIG. 2 with a Decision-Making Hand shown.

FIG. 6 shows the results on a screen of having pressed the split button.

FIG. 7 shows a screen where the player has taken a hit in the first Decision-Making Hand.

FIG. 8 shows the screen 2 displaying the final game status after the program automatically plays each of the dealer s hands.

FIG. 9 shows a screen with initial universal hands shown in the Decision-Making hand area of the screen.

FIG. 10 shows a screen where a hit resulting from pressing the double down button has been provided.

FIG. 11 shows a screen with further play of the double down game of FIG. 10.

FIG. 12 shows a screen with a player s universal hand of a blackjack shown in the Decision-Making Hand area.

FIG. 13 shows a screen displaying a further stage of the play of the game from FIG. 12.

FIG. 14 shows a screen displaying the results of the player having pressed the stand button.

FIG. 15 shows another embodiment of the video Twenty-One game of the invention.

FIG. 16 shows a notice within each hand indicating a stand has been elected or the player s count in those hands is fixed.

FIG. 17 shows a screen where the player has elected to take a hit on this play of hands from FIG. 16.

FIG. 18 shows a screen where a third decision on split hands has been begun.

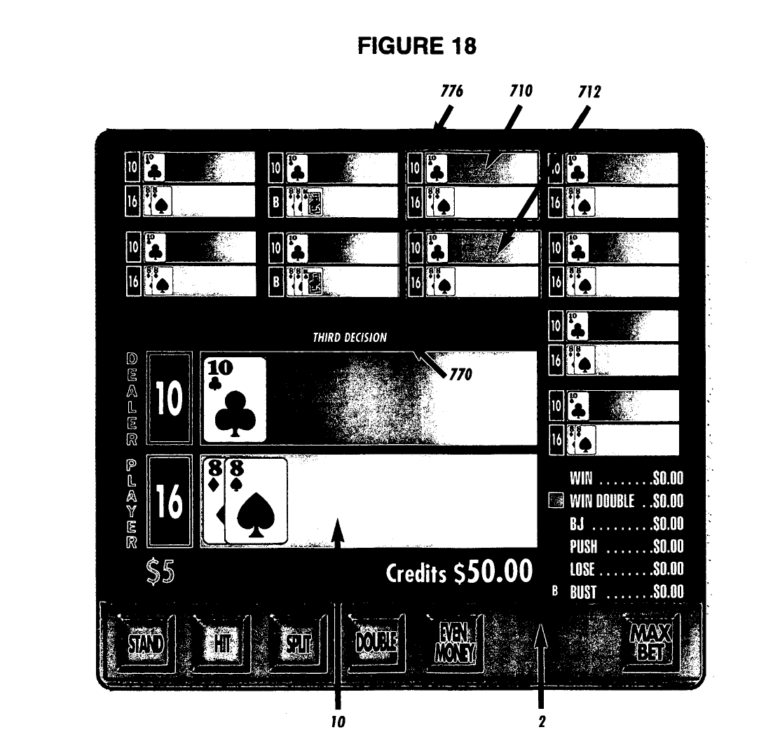

FIG. 19 shows a screen where a third decision on split hands has been completed.

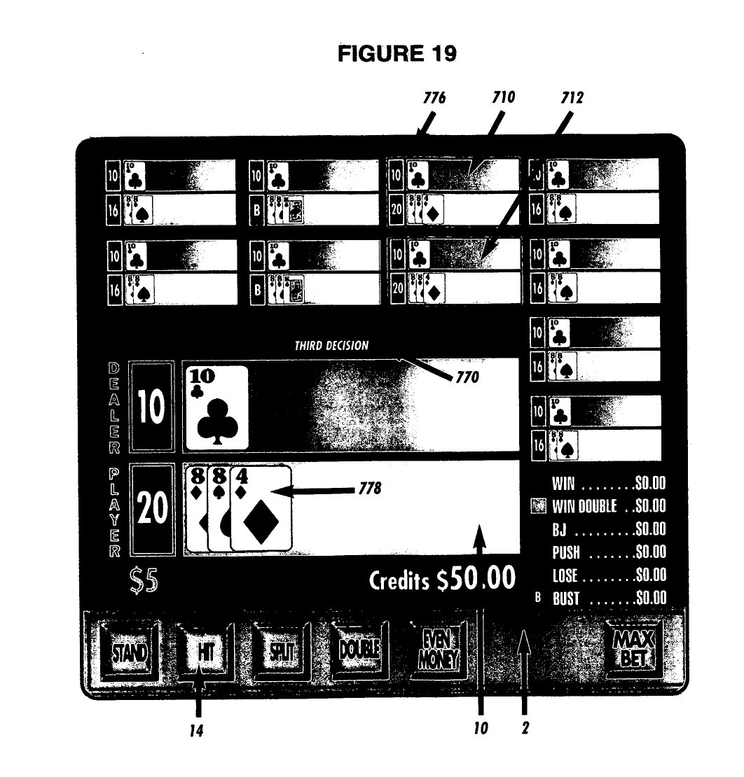

FIG. 20 shows a screen where a fourth decision on split hands has been begun.

FIG. 21 shows a screen where a fourth decision on split hands has been completed.

FIG. 22 shows the end screen 2 after all five decisions have been made by the player.

### DETAILED DESCRIPTION OF THE INVENTION

A video gaming system and game are played on a video gaming apparatus comprising at least a housing, video display system, and microprocessor. Additional desirable features include coin handling system, currency handling systems, currency and coin authentication systems, credit management systems, player controls, coin tray, signal light systems, audio system, and other conventional peripherals found on wagering apparatus and systems. The microprocessor and other memory elements are programmed and/or designed to enable play of the game and operation of the peripherals.

The fundamental game may be described as follows. A gaming apparatus with display system (e.g., CRT, video monitor, plasma device, LED, liquid crystal display, etc.) is controlled by programmed hardware and/or software to accept wagers, which may be in the form of credit, coins, tokens, currency, slips, or any other value indicating device or system. Upon acceptance of the wager, the display will provide an image of a dealer s hand of blackjack (e.g., one card face up or two cards, usually with only one card face up, so that only a preliminary estimation of the dealer s hand is provided) and the initial two cards of a player hand. Each machine is usually programmed to accept wagers in units that are multiples of a minimum wager that is to be placed in the play of the game. Units of minimum wagers usually may be, by way of non-limiting example, $0.05, $0.10, $0.25, $0.50, $1.00, $2.00, $5.00, $10.00, $25.00 or the like. When a minimum wager is provided, a single blackjack game (that is a single player hand and a single dealer hand) will be played against the single dealer hand according to the rules of blackjack or Twenty-One programmed in the machine. That game would be played to conclusion according to those rules. When multiples of the minimum wager are provided, a game format according to the present invention may be played. The microprocessor determines the number of different dealer hands that may be provided according to the amount of the wager made (up to a machine programmed into the machine, such as 5 dealer hands in a single game, 10 dealer hands in a single game, 100 dealer hands in a single game, or any whole integer number between 2-100 as a non-limiting example. Alternatively, before the player s hand is completely or partially disclosed (one card shown) or even after the dealer s top card is displayed, the player may elect the number of dealer hands that the dealer wishes to have in play against the player s hand. Upon identifying the total wagering amount, the initial wager is distribute according to programmed rules among the number of dealer hands determined or selected.

As an example, consider the following examples. Assume that the gaming apparatus has a maximum number of five dealer hands available against a single player hand. If the minimum wager is $5.00, and the player is playing an apparatus where the system is programmed to automatically distribute the wager among five dealer hands, the following event would occur. Five dealer hands (considered by the microprocessor as hands 1, 2, 3, 4 and 5) would be displayed, each dealer hand having a wager of $1.00 associated with the play of each hand. The player hand would be played to conclusion; that is, until the player decides that the hand will stand or the hand has busted. Each dealer hand would then be played to its individual conclusion, with the dealer s hand(s) being individually played automatically at the end of play of the player s hand. This would provide potentially distinct outcomes for each of the dealer hand/player hand combinations. If the initial wager were $23.00, hand 1 would be played for $5.00, hand 2 for $5.00, hand 3 for $5.00, hand 4 for $4.00 and hand 5 for $4.00. The machine would distribute the total wager amount equitably among the dealer hands, with, preferably, no more than a single wagering unit difference between any two hands. The hands need not be selected in linear order, and the program may randomly select which hands receive the larger or smaller amounts of the wager that is unequally distributable. For example, the machine may chose a random distribution of wagers as hand 1 would be played for $4.00, hand 2 for $5.00, hand 3 for $4.00, hand 4 for $5.00 and hand 5 for $5.00. This is less preferred as whenever the player hand that loses against the dealer s better resulting cards have the higher wager, there might be a concern by players that an unfair selection process was programmed into the system. The fact that wagering differentials were distributed in a uniform fashion would avoid that issue. After the player has played the uniform player s hand to a preliminary resolution (that is, the player has indicated on the system to stand, or is busted, or the like), the dealer s hand(s) would be played out according to the programmed rules of Twenty-One. The machine would then resolve wagers based on the rules of Twenty-One for each of the hands.

Another format of play within the scope of the invention is when the player selects the number of dealer s hands that are to be played in a single game. For example, if the player had selected five hands to be played, the play would be essentially indistinguishable from the method of play for the automatically programmed game described above with five dealer hands always available. However, there would be differences, for example, where the player selects 2, 3 or 4 hands or more. Selecting a single hand is effectively playing the gaming apparatus as a conventional Twenty-One gaming apparatus. In the event that 2 hands are selected by the player to be played, two hands (hand 1 and hand 2) would be provided. With a wager of $25.00, hand 1 would be played with a wager of $13.00 and hand 2 would be played with a wager of $12.00 according to the preferred rules of play. If the wager were $23.00, hand 1 would be playing with a $12.00 wager and hand 2 would be played with a $11.00 wager. If the player selected three player hands to be played (e.g., hand 1, hand 2 and hand 3), the wagers would be distributed as $9.00, $8.00 and $8.00, respectively. If the total wager were $23.00, the wagers would be distributed as $8.00, $8.00 and $7.00, respectively. As the hands are not disclosed until after the wager, there may also be a program where the player can allocate the wagers less proportionally. For example, if the player feels that hand 2 is winning disproportionately, the apparatus may have a function to allocate the wager more heavily towards one or more hands, yet requiring that all hands be played that are selected. The programming may also allow for the total wager to be allocated to less than all hands that are show or even to a single hand. In this event, hands to which no wager is allocated would either be played automatically by the program (without any possibility of player award) or would not be played at all, but would merely be shown on the display. For example, the player may elect to play $15.00 on hand 2 and $5.00 on hand 4, and $3.00 on hand 5, before either the player s cards or the dealer s cards are shown. Hand 1 and hand 3 would preferably be played out automatically (in sequence, with hand 1 being played automatically, immediately, then hand 2 played by the player, and then hand 3 played automatically after the players stands or busts with hand 2).

There are also a number of variations or variants of the play within this generic format of the system. For example, a single dealer hand could be displayed, with each of the player hands displayed in sequence or in a pattern in an area of the screen. In this format it would be desirable, but not essential, to have the dealer hand(s) clearly distinguished from the player hands. This can be done most simply by having the single player s hand larger than each of the dealer hands, or by having the background color or shape of the dealer s hand a different background color or shape than the player hands. Each of the player hands may be played according to the rules of Twenty-One that are programmed into the system. Preferably, these are standard rules, with double downs, splitting hands, blackjacks, surrender, and the like available for play. It is also conventional, but optional, to always have the dealer s hand(s) higher on the screen then the player s hand.

### First Variant

The proposed game is an electronic casino game variation of Blackjack, with the ability to play multiple hands under a specific format and rules. The game is played with the following rules:
1) A Player plays a single player hand of blackjack against one or more Dealer (machine or processor) hands.
2) The Player makes an initial wager for each hand that the Player intends to play against a Dealer s hand. The wager may even be placed against selected dealer hand(s), with no exposed cards on the hands. Otherwise, the wagers will be automatically distributed.
3) Each separate Dealer s hand is displayed in one region of the screen and the Player s universal hand is shown in its own region of the screen.
4) A preferred method is to have the primary Player s hand at the bottom of a display screen and each of the Dealer s hands positioned above each resulting Player s hand on the screen.
5) A normal sequence of blackjack is initiated between the universal Player s hand (that is, a single set of two cards are dealt as the Player s hand). That Player s hand is played a single time, and the result is provided against all of the dealer s hands. If the play of the Player s hand results in a count of 21, that count of twenty-one is played against each of the dealer s hands. If the player busts on the play of that single hand, all of the hands are busted, and all wagers lost.
6) The Player receives two cards face up and the Dealer receiving one card face up in each hand. The face up card for the dealer is the same in each dealer hand.
7) The Player plays the player s hand to the conclusion that the Player desires with respect to the Player s initial hand, the universal hand. This may include hitting, doubling down, splitting, standing, surrendering or taking insurance.
8) The Player s resulting final hand (including a bust) is displayed on the screen.
9) The Dealer s hand(s) are then played automatically according to the general rules of Blackjack—with the Dealer required to take a hit with a count of 16 or less and being required to stand with a count of 17 (house rules may vary as between hard 17 s and soft 17 s).
10) Any additional Dealer s hands that an initial wager had been made upon in step 1 will then be independently played with the same first up card according to the rules of Blackjack by the machine against the Player s resulting final hand (resulting in step 7).
11) Each Dealer s hand is compared with the Player s resulting final hand and each game resolved according to the rules of Blackjack as controlled by the machine.

### Second Variant

The second variant of a proposed game has the following steps:
1a) A Player makes wagers based on the number of hands to be engaged in by the Player.
2a) The Player is dealt a single initial hand (two cards) that is displayed in any multiple number of positions on a video screen (for example, in 2, 3, 4, 5, 10 positions), with a single Dealer s hand on the top of the screen or above/below each of the Player s hands shown.
3a) Each initial hand may be played differently by the Player against the Dealer s common displayed (up card) card. For example, a pair of eights as the Player s hand may be hit on some displays or split in others, or undergoes a stand in another position to moderate the Player s position with a bad hand.
4a) The Player makes an initial wager for each hand (prior to viewing the hand or a partial hand) that the Player intends to play against a Dealer s hand. The Player s hands will be separated into groups based upon the number of positions allowed for in the game and the number of separate decisions allowed on the Player s hand. For example, if there are ten Player play positions allowed (i.e., 10-Hand Multiplay Blackjack), ten identical initially dealt hands will be displayed, one in each Player play position. The Player is allowed at least two decisions on the initially dealt Player s hand. Using the same example above, if five decisions are allowed, then each decision will become ⅕ of the total number of wagered hands, or in this case, each group would contain two identically played Player s hands. When the total number of hands is not evenly divisible by the number of decisions, the number of hands are distributed in groups in unequal amounts with no greater inequality between each group of more than 1. For example, with 10 Player hand positions, two separate decisions will result in two groups (group 1 being positions 1, 2, 3, 4, 5; group 2 being positions 6, 7, 8, 9,10). Three decisions would result in three groups (group 1 being positions 1, 2, 3, 4; group 2 being positions 5, 6, 7; group 3 being positions 8, 9, 10).
5a) Each separate Dealer s hand (an identical initial hand showing one card face up, with separate and distinct play on each Dealer s hand associated with each resulting Player s hand) is displayed in one region associated with the Player s hands on the screen and the Player s hand(s) is shown in its own region of the screen.
6a) A preferred method is to have the Player s hands lower on the display screen and each of the Dealer s hands positioned above each of the Player s hands on the screen.
7a) A normal sequence of blackjack is initiated between each of the Player s hand and the Dealer s hand, with the Player receiving two cards face up and the Dealer receiving one card face up.
8a) The Player plays the first Player s hand (and therefore the first group of hands) to the conclusion that the Player desires with respect to the Player s initial dealt cards. This may include hitting, doubling down, splitting, standing, surrendering or taking insurance.
9a) The Player s resulting final first hand (including a bust) or group of hands is displayed on the screen. The Player then, without completion or disclosure of the Dealer s hand, proceeds to the second decision of play in regards to the Player s initial cards, and plays out that hand or groups of hands to an independent Player s hand conclusion, the original first two cards being identical to the first hand. All subsequent Player hands (up to the total number of decisions allowed for and paid for) are also played to conclusion in the manner above.
10a) After all Player hands have been concluded, or after each Player s group of hands has been concluded, each of the Dealer s hands associated with each of the resulting Player s hands is then distinctly played according to the general rules of Blackjack. The Dealer is required to take a hit with a count of 16 or less and being required to stand with a count of 17 (house rules may vary as between hard 17 s and soft 17 s).
11a) At the completion of the Dealer s play of each hand or all of the hands, all Dealer s hands associated with each of the resulting Player hands are displayed.
12a) Each of the individual Player hands is then resolved against the variously played Dealer s hand. It is desirable to have each of the Dealer s hands positioned opposite the final resulting Player hands played independently (with the same up card), as this offers greater exercise of strategy for the player.

### Third Variant

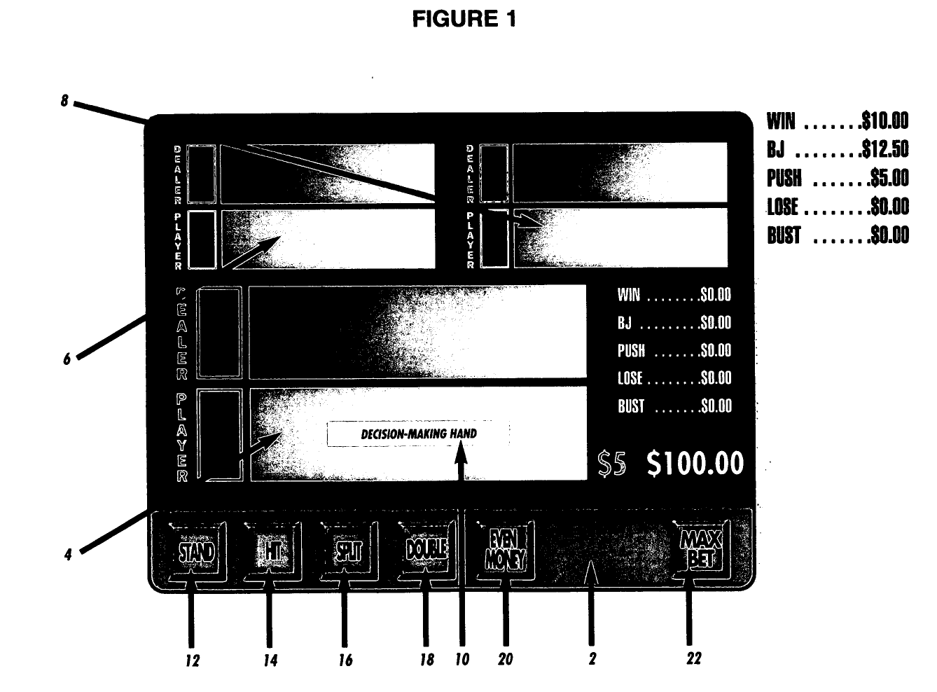

These formats of play can be further appreciated and understood by reference to the Figures. FIG. 1 shows a blank touch-screen screen set-up for play of Triple Play“ blackjack. The screen 2 shows available play area displays for the games 4, 6 and 8. In game 2, the player hand area 10 is referred to as the DECISION-MAKING HAND for convenience, although this wording does not have to be shown on the screen 2. Six player control keys 12 (Stand), 14 (Hit), 16 (Split), 18 (Double), 20 (Even Money) and 22 (Max Bet) are shown. Alternative buttons, functions, terms, and additional buttons are also available (e.g., surrender, security, change, and cash out buttons are not shown, but some are common on video gaming apparatus and could be used here.). Rather than the touchscreen display shown in this FIG. 1, a physical gaming apparatus(not shown) with physical buttons, levers, pull arms or other controls may be used.

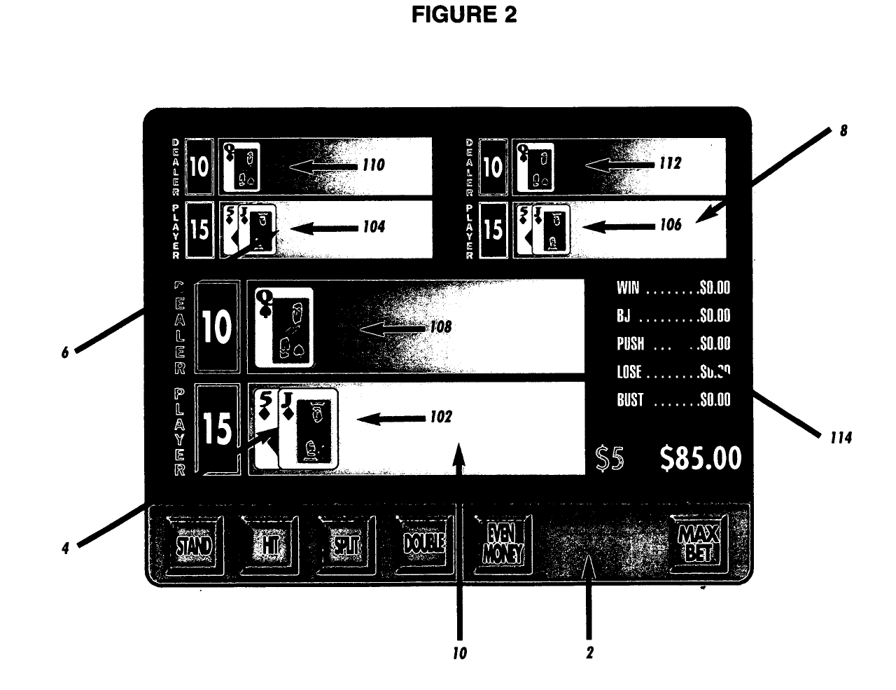

FIG. 2 shows the beginning of a game of Triple Play“ blackjack with a $15.00 initial wager, resulting in three hands where $5.00 is played on each hand. On the display 2 are shown the three screen hand display areas 4, 6 and 8. In the Decision-Making Hand 10, the player s universal initial hand 102 of a 5 and a Jack is displayed. That identical or equivalent hand is shown in screens 6 and 8. The dealer s initial universal hand 108 is also shown on the screen 2. That universal hand 102 is also shown on screen areas 110 and 112 on the other hands that are played during the game. A screen area 114 is dedicated to game play status information, such as the win amount totaled on all hands, blackjack awards (BJ), push compensations, losses and busts.

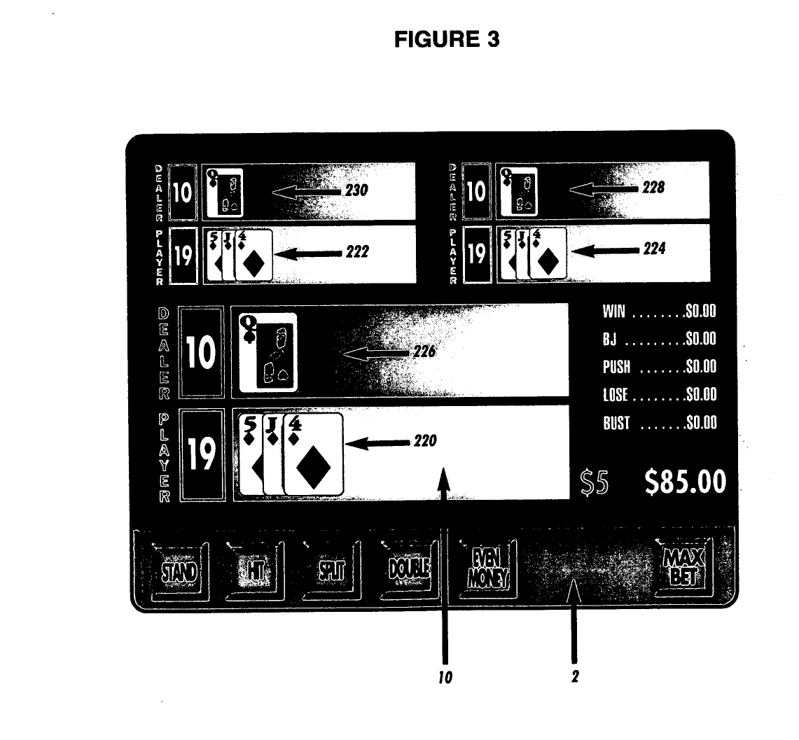

FIG. 3 shows a screen 2 at a further stage of play of the game. At this stage, the player has elected to take a hit on the Decision-Making Hand 10 , producing a count in the player s universal hand 220 of 19. That count of 19 is also shown on player hands 222 and 224 in this play format where the play of the Decision-Making Hand is carried onto every other hand, rather than the player playing each player hand separately. The value of the dealer s hands 226, 228 and 230 remains constant at this point in the play of the game.

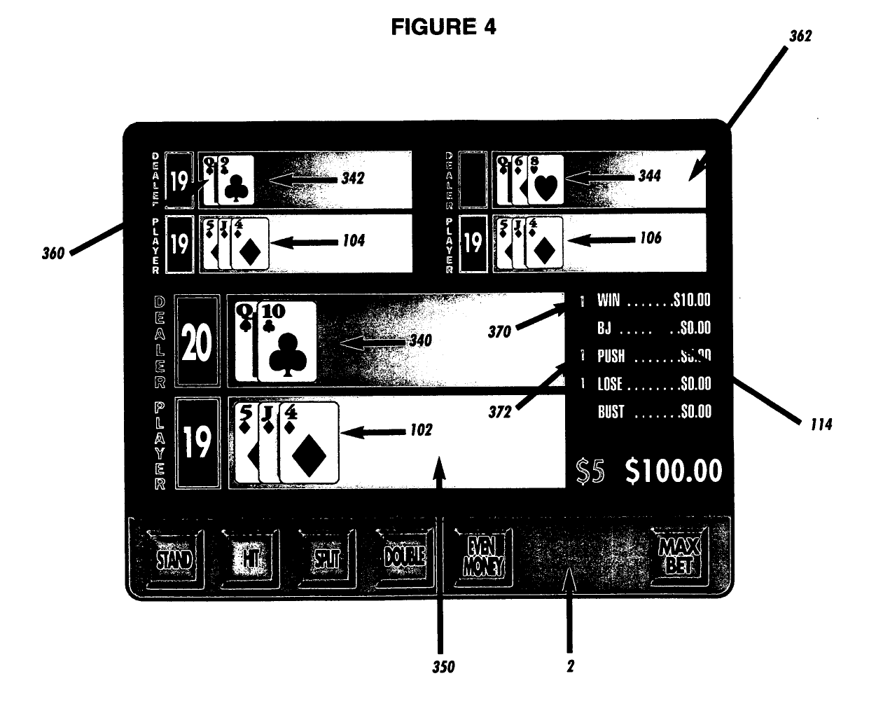

FIG. 4 shows a further stage of the game on screen 2. In the play of the first game 350, the player s hand 102 remains at the value of 19 from earlier play. The dealer has automatically stood on the hand, since the point count 340 was 20. The programming also has hand 2 360 stand with a point count 342 of 19 on the original two cards. The dealer has automatically taken a hit on hand 362 to bust with a point count 344 of 24. The result status area 114 automatically indicates (by programming) that the player won two hands ($10.00 in WIN) and pushed another hand ($5.00 PUSH). The tone or color of lights 370 and 372 have altered to emphasize the results.

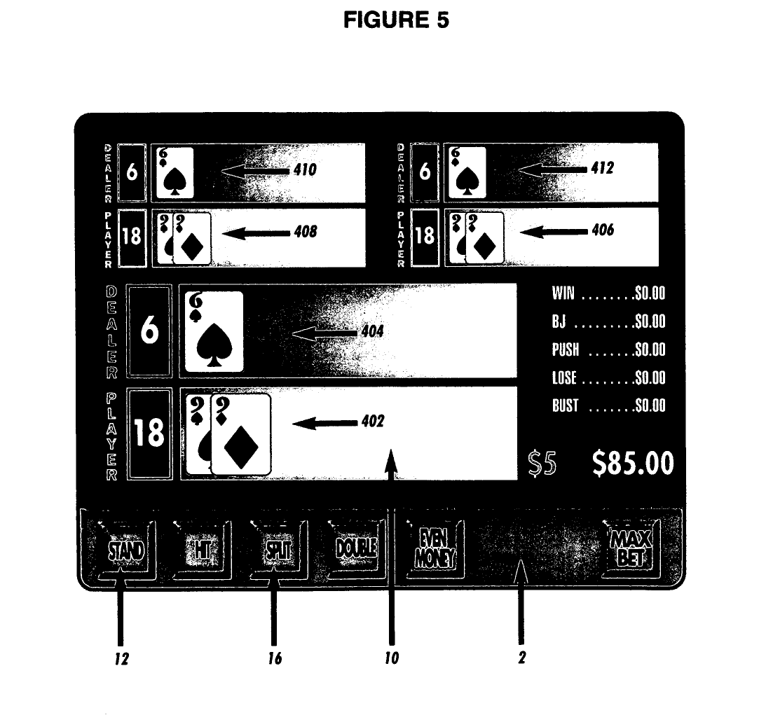

FIG. 5 shows a screen 2 with a Decision-Making Hand 10 shown. The player s universal initial hand 404 has an initial value of 18 and the Dealer s universal initial hand 404 has an exposed card value of 6. The strategy on this hand might well be to either stand (the player pushing touch screen 2 button 12) or to split the pair (the player pushing touch screen 2 button 16). In the interest of explaining operation of the system, the player will elect to split the pair by pressing button 16.

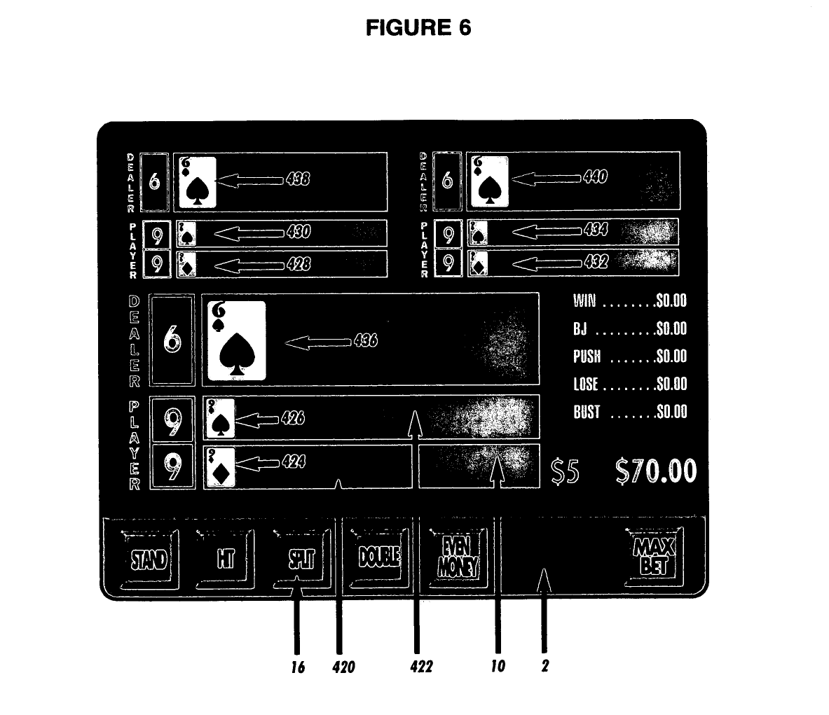

FIG. 6 shows the results on the screen 2 of having pressed the split button 16. The display in the Decision-Making Hand 10 shows two hands 424 and 426 of a single card in each hand. Identical hands are also shown in the other games as hands 428, 430, 432 and 434. The Universal dealer initial hand 436, 438 and 440 remains unchanged against this initial step in play of the game. At this point, the player will play each of the player hands 424, 426, 428, 430, 432 and 434 according to normal game rules. According to the rules of play or options provided to the player, the play of hand 424 may carry directly to hands 428 and 432, or each hand may be played separately. The same potential exists for the play of hand 426 in relationship to the play of hands 430 and 434. The play of hand 424 has no effect on the play of hand 426 or the play of hands 430 and 434. Additional money from the credits store or additional currency/coins/tokens must be used to effect the split hands, as is understood in normal play of Twenty-One.

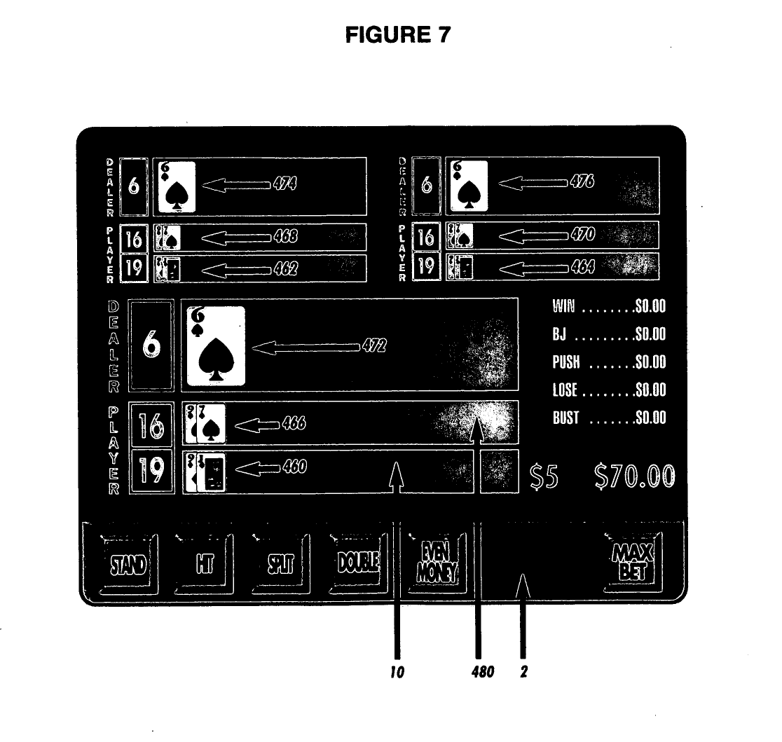

FIG. 7 shows a screen 2 where the player has taken a hit in the first Decision-Making Hand 10 and the second Decision-Making Hand 480. The decisions, hits or effects on each of the Decision making hands 10 and 480 are carried onto the corresponding hands 462, 464, 468 and 470 in the other games. The dealer s hands 472, 474 and 476 have not changed.

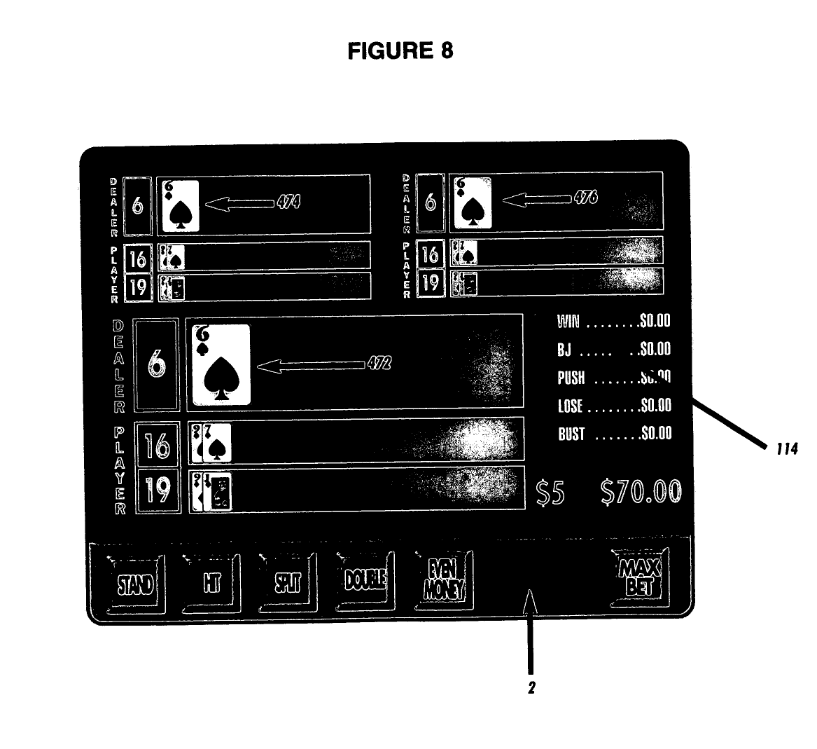

FIG. 8 shows the screen 2 displaying the final game status after the program automatically plays each of the dealer s hands 472, 474 and 476, the results being, respectively, a count of 21 in dealer hand 472, a count of 18 in dealer hand 474 and a count of 26 (a bust) in dealer hand 476. The total of wins, losses and pushes are displayed in the game status area 114.

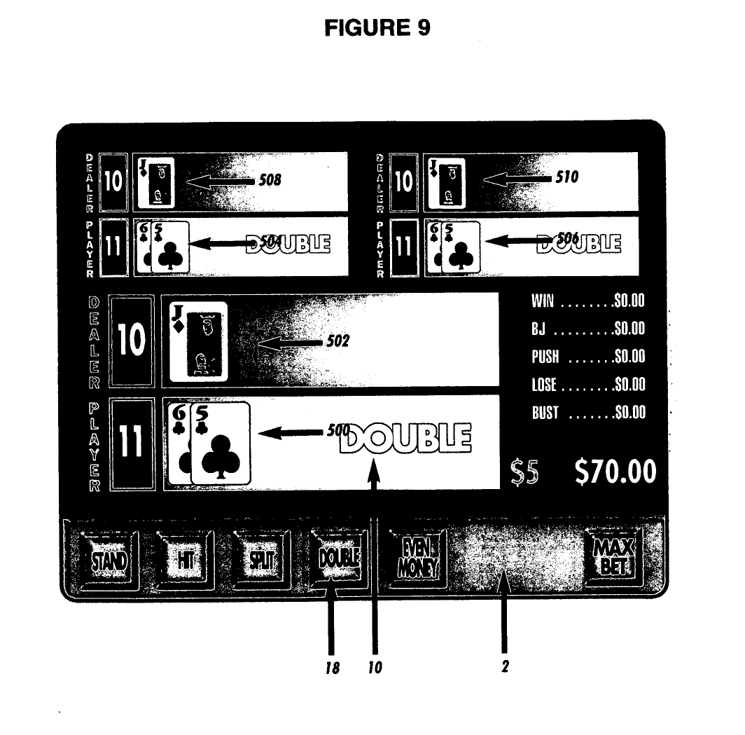

FIG. 9 shows a screen 2 with initial universal hands 500 and 502 shown in the Decision-Making hand 10 area of the screen 2. The point count of 11 suggests that the player may elect to press the double down button 18 as the strategy in the game.

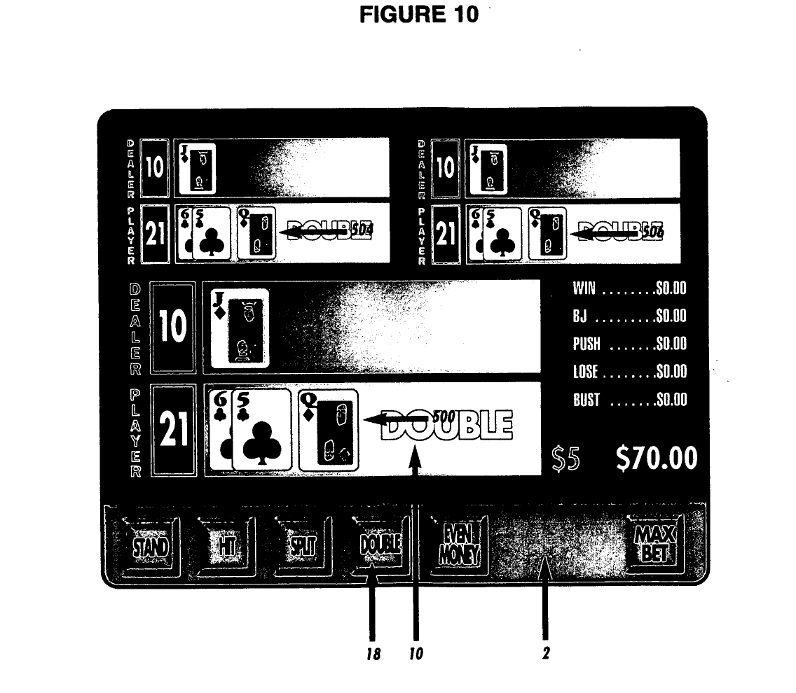

FIG. 10 shows a screen 2 where a hit (resulting from pressing the double down button 18) has been provided. The effect of the hit is a point count total of 21, which is carried over from the Decision-Making Hand 10 to corresponding hands 504 and 506.

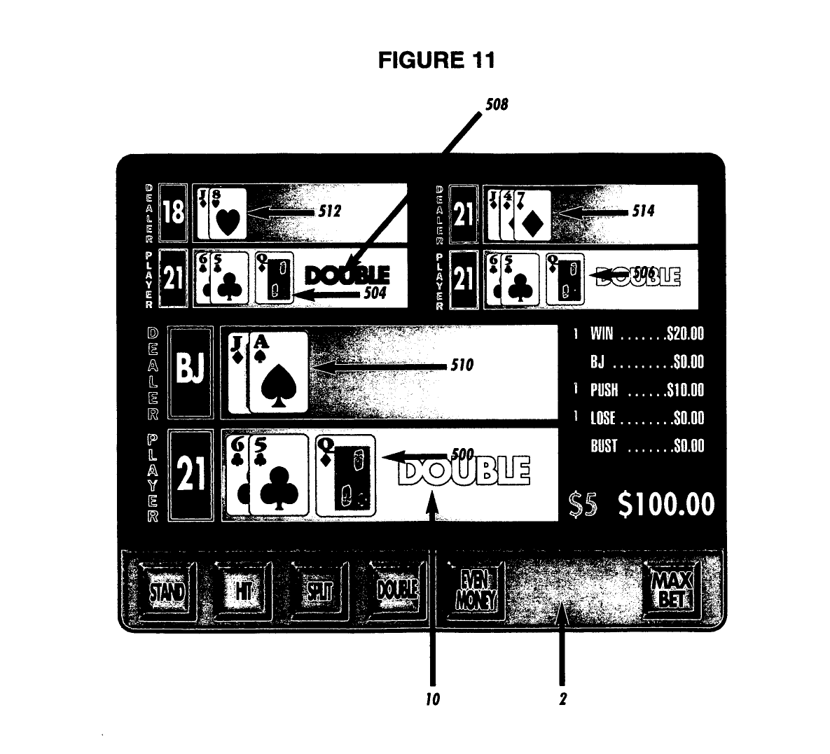

FIG. 11 shows a screen 2 with further play of the double down game of FIG. 10. The automatic play of the dealer s hands have produced a blackjack in hand 510, a count of 18 in hand 512 and a count of 21 in hand 514. This provides, respectively, a loss, a win and a push for the player. A background symbol 508 of DOUBLE is displayed to provide notice of the game play strategy.

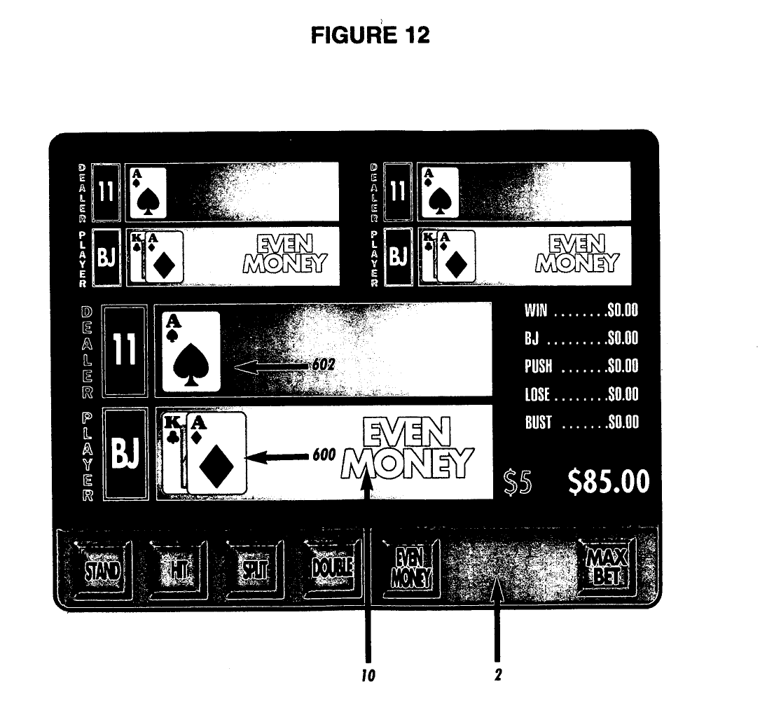

FIG. 12 shows a screen 2 with a player s universal hand 600 of a blackjack shown in the Decision-Making Hand 10 area. The universal dealer hand 602 displayed card is also an Ace, offering the player options of standing or accepting even money (effectively taking an insurance wager).

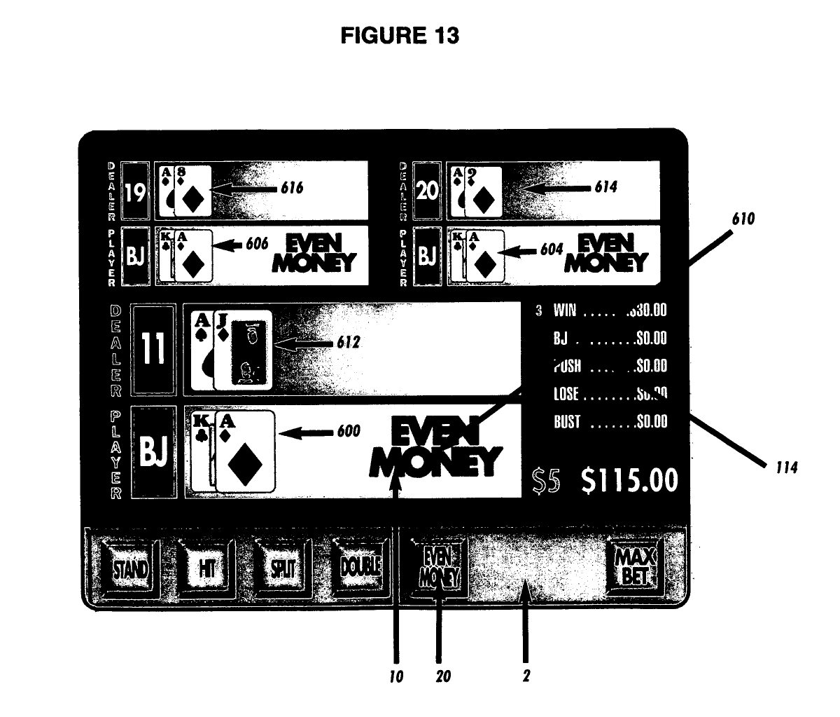

FIG. 13 shows a screen 2 displaying a further stage of the play of the game from FIG. 12. When the player has pressed the EVEN MONEY button 20, a display is shown on each player hand 600, 604 and 606 stating EVEN MONEY. The dealer s hands 612, 614 and 616 are shown played to conclusion, even though with the election of even money. This is done to reinforce or challenge the player s decision.

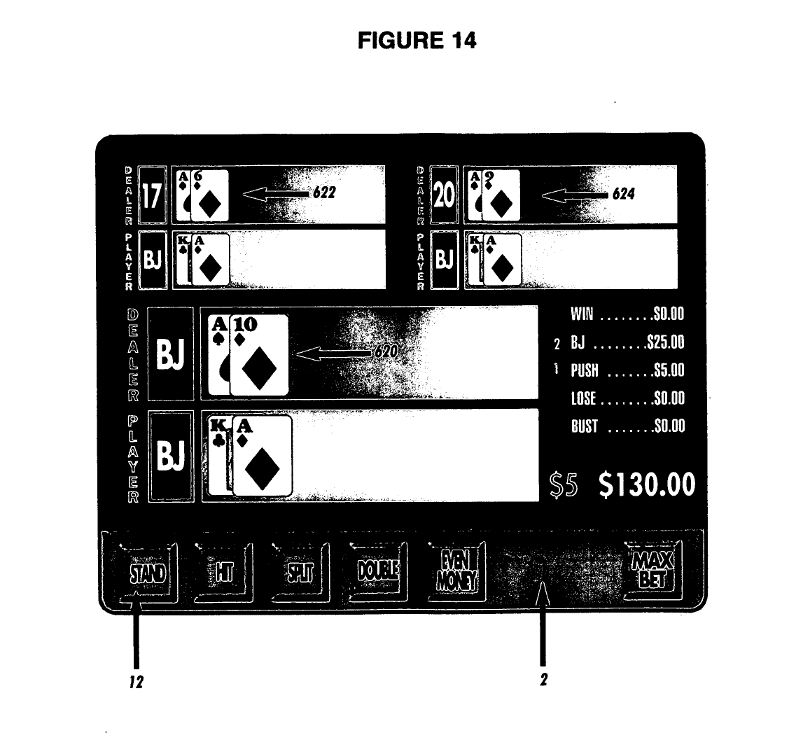

FIG. 14 shows a screen 2 displaying the results of the player having pressed the stand button 12 and the microprocessor playing out the dealer s hands 620, 622 and 624. The apparatus may also provide indicators, symbols, words or the like in frames for each hand to emphasize results, such as animation that shows or says Blackjack! or BUST or 21 or WIN or other effects.

It is clear to one skilled in the art that other variations in the game, both conventional and unconventional may be used to alter subtleties of play of the generic game described herein. These may be done without altering the underlying concept of play of the invention, and the game, even with those variations or additions are intended to be within the scope of this description and the claims.

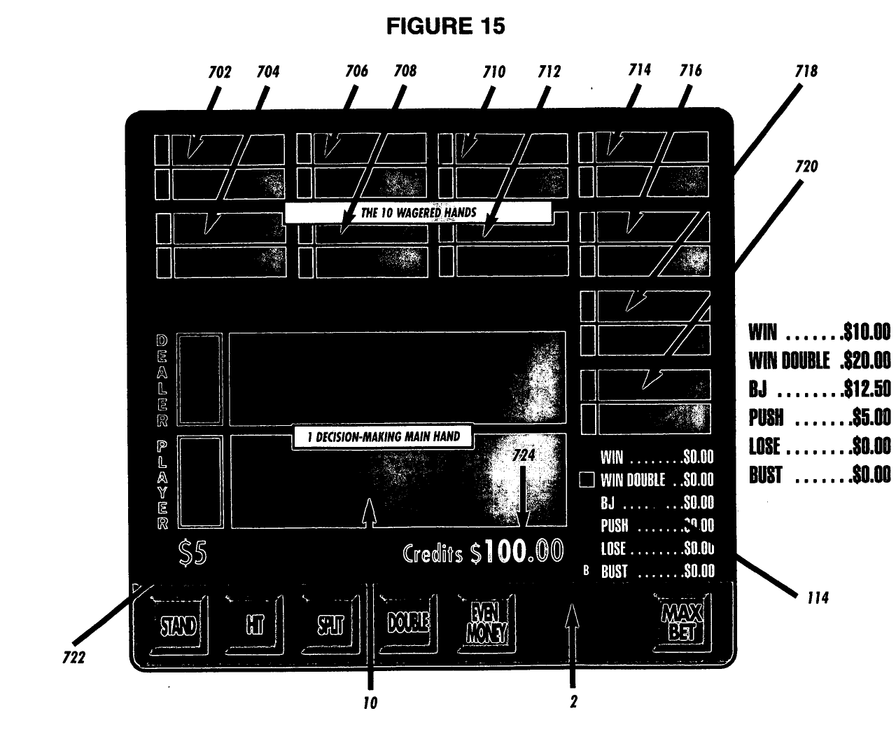

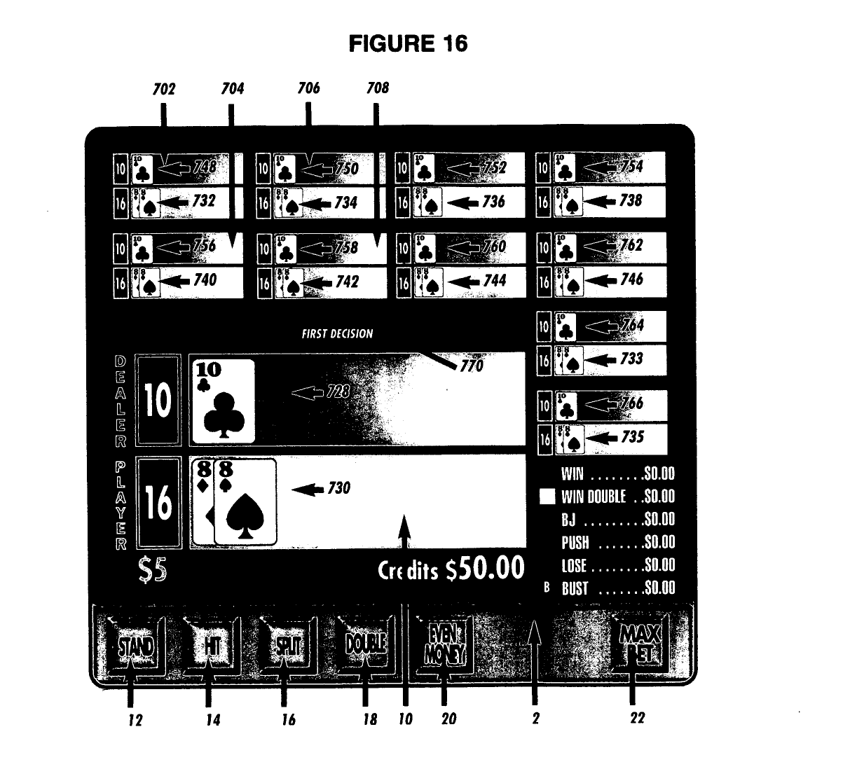

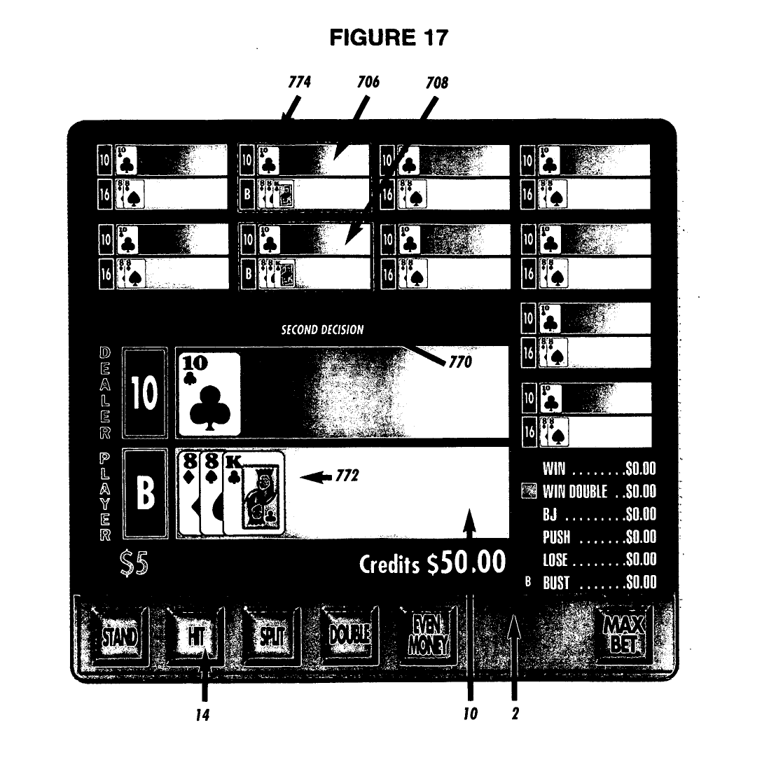

FIG. 15 shows another embodiment of the video Twenty-One game of the invention. In this format, the screen 2 has a Decision-Making Hand 10 and 10 wagered hands 701, 704, 706, 708, 710, 712, 714, 716, 718 and 720. Also shown on the screen 2 are the win status field 114, the denomination unit wagered per hand 722 and the credits remaining 724. In the play of the format of FIG. 15, a player s hand is dealt and shown in the Decision-Making Hand 10 as a pair of eights 730. The identical hand (it could be an equivalent hand with different suits as suits are of no consequence) is displayed in the 10 wagered hands 732, 733, 734, 735, 736, 738, 740, 742, 744 and 746. A dealer s hand (or exposed card) is shown as a 10 of clubs 728. That dealer s hand is again identically or equivalently (e.g., a 10, Jack, Queen or King could be used) in the 10 wagering screens as dealer s hands 748, 750, 752, 754, 756, 758, 760, 762, 764 and 766. In one embodiment of this format, if 10 wagers are placed, the Decision-Making Hand 10 is not actually wagered on and no awards are made, but rather it provides an enlarged view of the cards. The Decision-Making Hand may alternatively be an active wagering hand. In this format, where the Decision-Making Hand 10 is not part of the wager, there is an indicator box 770 that exists or is displayed at an appropriate time. The indicator box 770 identifies that a decision is to be made with regard to the play of a hand or hands. For example, to limit the number of decisions that can be made in a single play, the machine may automatically illuminate a number of hands (e.g., 702 and 704), and the box 770 indicates that a decision is to be made on the illuminated hands. Alternatively, the player may elect to illuminate any number (at least 1) or all of the hands (e.g., 10) on which wagers have been placed so that the first decision will apply to that number of hands. This offers significant control to the player. For example, in another set of cards, if the player s cards totaled 11 and the dealer s exposed card was a 10, the player might want to play conservatively (playing for at least a push), and break the decision into two groups, doubling separately on each group of five hands, in the hope that at least one double down will be a ten count. Similarly, in the present case, with a pair of eights (a 16 count) facing a ten count for the dealer, the player may wish to take separate hits on various sets of hands (e.g., a separate hit on hands 702 and 704 as one set, and 706 and 708 as another set) to reduce the likelihood of losing all hands with a single hit on a bad hand. It is assumed that the stand button 12 is pressed to play hands 702 and 704 in this game play of those hands. A notice may appear within each hand 702 and 704 indicating that a stand has been elected or that the player s count in those hands is fixed at FIG. 16. After that decision has been made, the decision box 770 may indicate that a second decision is to be made. At this time, a different series of boxes (e.g., 706 and 708) may be highlighted or otherwise indicated as being controlled by the second decision indicated in the decision block 770. As shown in FIG. 17, the player elected to take a hit on this play of hands 706 and 708, and a King is shown in the Decision-Making Hand box 10 and is also shown in game hands 706 and 708 which hands are shown with a highlight 774. This busts hands 706 and 708 and this may indicated on the hands with a notice, such as words that say BUSTED or lose or some other notice. After completion of this decision, the decision box 770 now indicates that a third decision is to be made, with hands 710 and 712 highlighted 776. In the play of this set of hands, the player presses the HIT button 14 and receives a 4 count card for a total count of 20 in the Decision-Making hand 10 shown as 778. The play of hands 706 and 708 are then played to conclusion with the player now indicating STAND by pressing the STAND button 12.

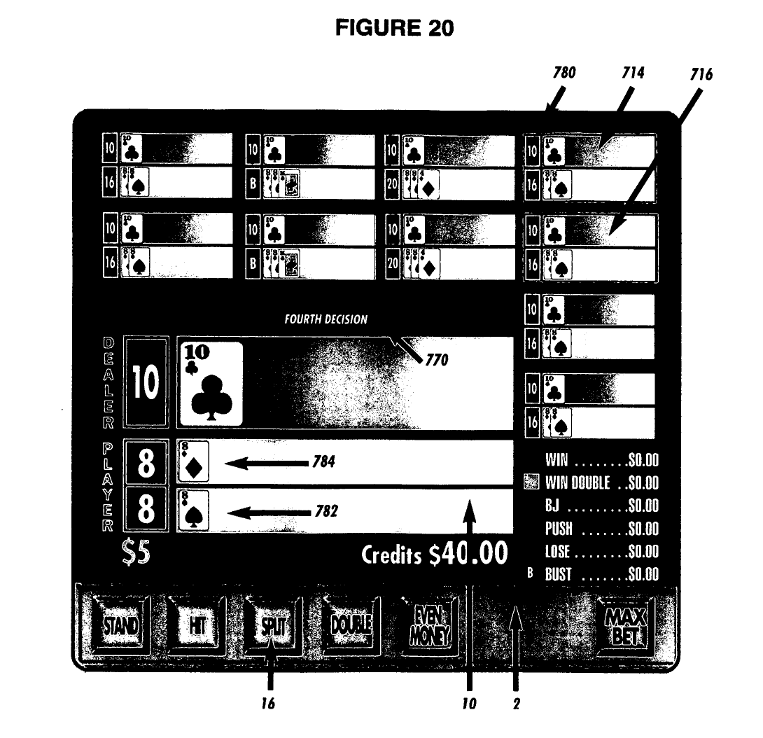

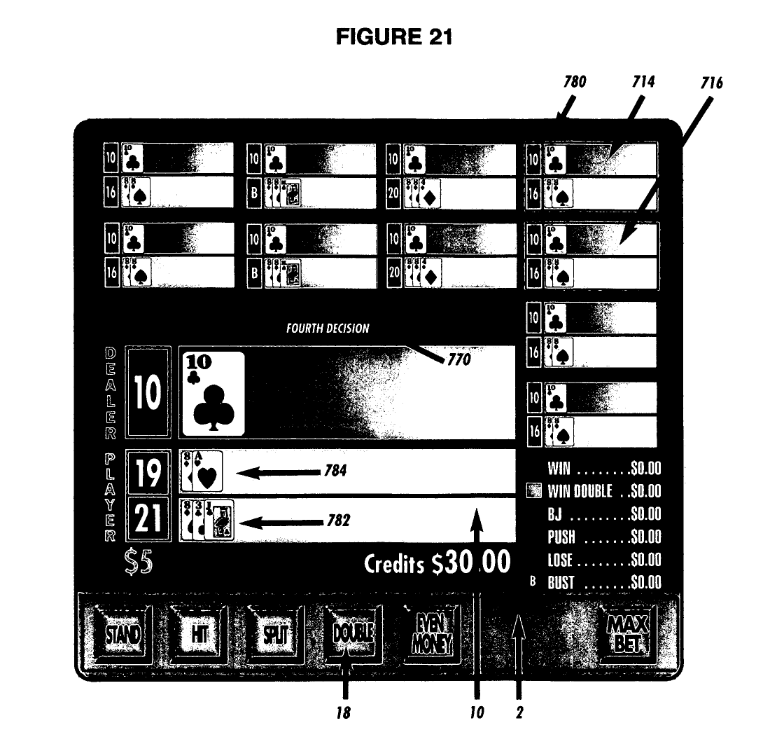

In FIG. 20, the decision box 770 now indicates that a fourth decision is to be made on hands 714 and 716. The player has pushed the SPLIT button 16 and hands 782 and 784 are displayed with a single as the initial player s hands. Hands 714 and 716 are shown highlighted 780. Those hands may either be split to shown two hands, or the hands may otherwise be identified as being played in a particular manner. In this play shown on FIG. 21, a count of 18 is received in hand 784 and an initial count of 11 was received on hand 782, for which the DOUBLE button 18 was pressed, costing an additional $15 from the original wager, $5 for the split and an additional $10 for the double down on hand 782 which is played on two hands 714 and 716.

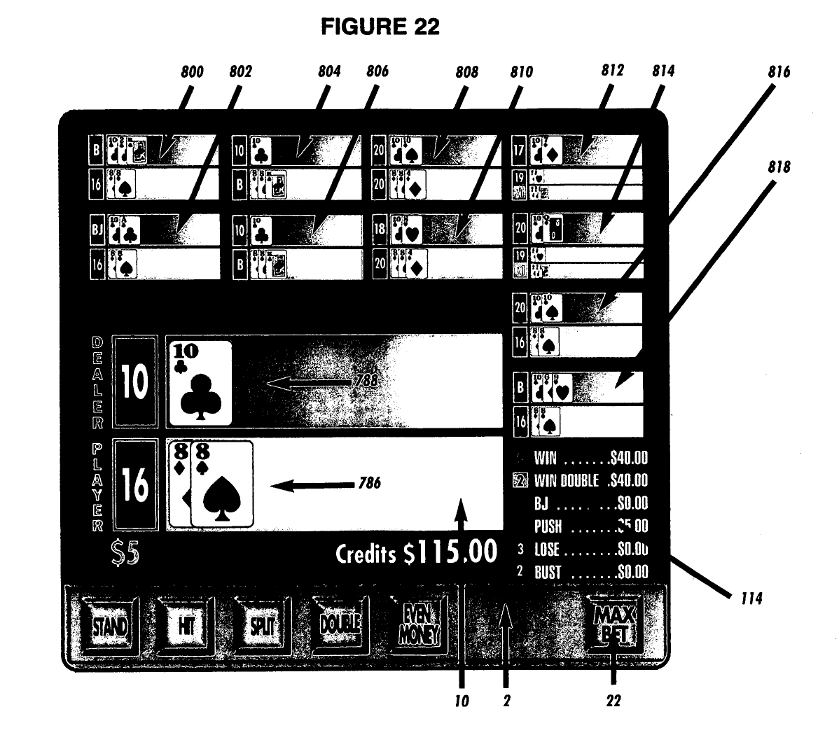

FIG. 22 shows the end screen 2 after all five decisions have been made by the player and all of the sets of dealer s hands 800, 802, 804, 806, 808, 810, 812, 814, 816 and 818 have been automatically played to conclusion according to the rules of the game of Twenty-One programmed into the microprocessor. The dealer s hands may be played according to a number of different automatic formats. For example, hands 800 and 802 that were played against a single player s decision made in FIG. 16 may be played identically or independently. In FIG. 22, hands 800 and 802 were played independently. Similarly, hands 804, 806, 808, 810, 812, 814, 816 and 818 were played independently, even though certain combinations of player hands were played with a single decision. Original hands 796 and 798 are, by way of example, shown on the final screen 2. Other play of the dealer s hands may be programmed or elected into the programming of the microprocessor for play of the game. As shown in FIG. 22, all dealer s hands 800, 802, 804, 806, 808, 810, 812, 814, 816 and 818 have been automatically played to conclusion. They may have been played by independent play for each set of player s hands (such as 702 and 704, and 706 and 708, and 710 and 712, etc.), may have been played for each first hand in the sets (e.g., dealer hands 800, 804, 808, 812, and 816 as a set, and 802, 806, 810, 814 and 818 as a set. The wins, losses and pushes, as well as payouts and credits are displayed on the status area 114 of the screen 2. At the conclusion of this complete play of the game, the player may begin play of another game by pressing the MAX BET button 22 or otherwise initiating a wager.

What is claimed:

1. A method of playing multiple card games on video gaming apparatus played by at least one player based on the conventional manner of play of Twenty-One comprising:
a) at least one player making at least a first wager and a second wager, the first wager and the second wager defining a total initial wager, the total initial wager being equal to or exceeding at least two minimum wagers allowed for play of one of said multiple card games;
b) dealing an initial two cards to the at least one each player in a first hand and dealing an equivalent hand to at least one additional player hand positions controlled by the at least one player to form additional player hands, the additional player hands and the initial first hand forming multiple player hands;
c) distributing the total initial wager among the multiple hands so that at least two hands have wagers equal to or exceeding the minimum wagers allowed for play of one of said multiple card games;
d) dealing at least one face up card to the dealer comprising the dealer's hand, the at least one face up card being provided relative to each player hand in the multiple player hands;
e) with respect to each player's first wager and a player s hand associated with the first wager, the at least one player playing out the initial player hand to a conclusion of the play of the initial player hand;
f) the additional player hands being played either i) identically to the conclusion of play of the initial hand or ii) individually according to the rules of Twenty-One;
g) after i), all dealer s hands provided relative to each player s hands are either played out independently according to the rules of Twenty-One, and after ii), all dealer s hands are played out identically according to the rules of Twenty-One;
h) all wagers are resolved on the play of each of the multiple card games according to the rules of Twenty-One.

2. The method of claim 1 wherein the additional player hands are played identically to the conclusion of play of the initial hand according to the rules of Twenty-One and all dealer s hands provided relative to each player s hand are played to conclusion independently according to the rules of Twenty-One.

3. The method of claim 1 wherein the additional player hands are played individually according to the rules of Twenty-One and all dealer s hands provided relative to each player s hands are played out identically according to the rules of Twenty-One.

4. A method of playing multiple card games on video gaming apparatus played by at least one player based on the conventional manner of play of Twenty-One comprising:
a) at least one player making at least a first wager and at least a second wager, the first wager and the second wager defining a total initial wager, the total initial wager being equal to or exceeding at least four minimum wagers allowed for play of one of said multiple card games;
b) dealing an initial first hand of two equivalent cards to the at least one each player in a first hand, second hand, third hand and fourth hand positions controlled by the at least one player to form a total of at least four player hands, the at least four player hands forming multiple player hands;
c) distributing the total initial wager among the multiple player hands so that at least four hands have wagers equal to or exceeding the minimum wagers allowed for play of one of said multiple card games;
d) dealing at least one face up card to the dealer comprising the dealer's hand, the at least one face up card being provided relative to each of the four player hands in the multiple player hands;
e) the player s first hand being associated in play with at least one other of the second player s hand, the third player s hand, or the fourth player s hand to form a first group of player s hands for play against dealer s hands;
f) with respect to each player's first wager and a player s hand associated with the first wager, the at least one player playing out the first player s hand and the associated player s hand to an identical conclusion of the play of the first player hand;
g) at least two remaining player s hands not associated with the player s first hand form a second group of associated player s hands are played to conclusion in an identical manner according to the rules of Twenty-One;
h) after all player s hands have been concluded and all dealer s hands have been concluded relative to each player s hands according to the rules of Twenty-One, all wagers are resolved on the play of each of the multiple card games according to the rules of Twenty-One.

5. The method of claim 1 wherein the third player s hand and the fourth player s hand are associated in play and are played to an identical conclusion of the play of the third player s hand.

6. The method of claim 4 wherein all dealer s hands are played out independently.

7. The method of claim 4 wherein associated player s hands have dealer s hands played out to conclusion according to the rules of Twenty-One separately with regard to each set of associated player s hands.

8. The method of claim 4 wherein at least 5 player s hands are dealt and at least two associated groups of player s hands are played to conclusion according to the rules of the game of Twenty-One.

9. The method of claim 7 wherein each dealer s hand associated with a group of player s hands is played identically.

10. The method of claim 7 wherein each dealer s hand associated with a group of player s hands is played independently.

11. The method of claim 8 wherein each dealer s hand associated with a group of player s hands is played identically.

12. The method of claim 8 wherein each dealer s hand associated with a group of player s hands is played independently.

13. The method of claim 4 wherein the additional player hands are played individually according to the rules of Twenty-One and all dealer s hands provided relative to each player s hands are played out identically according to the rules of Twenty-One.
